(19) United States
(12) Patent Application Publication
(10) Pub. No.: US 2017/0287080 A1
(43) Pub. Date: Oct. 5, 2017

(54) URBAN PROFESSIONAL GENOME

(71) Applicant: LinkedIn Corporation, Mountain View, CA (US)

(72) Inventors: Vijayragunath Aruswamy, Dublin, CA (US); Hongmou Zhang, Cambridge, MA (US); Iva Bojic, Singapore (SG); Lyndsey Rolheiser, Somerville, MA (US); Stanislav Sobolevsky, Jersey City, NJ (US); Anthony Phong Vanky, Cambridge, MA (US)

(21) Appl. No.: 15/086,283

(22) Filed: Mar. 31, 2016

(51) Int. Cl. G06Q 50/00; H04L 29/08; H04L 12/58; G06Q 10/10

(52) U.S. Cl. CPC G06Q 50/01; G06Q 10/105; H04L 67/306; H04L 51/32

(57) ABSTRACT

A professional social networking system identifies occupations and locations of persons in a city from profiles of the persons in the system. For each city or neighborhood, identified occupation and industry, the system calculates different metrics of interpersonal connectivity and compares them to a model constructed with respect to average nation-wide trends. The system selects cities and neighborhoods as well as occupations and industries that over- or under-perform versus the given model and recommends actions for promoting the certain occupations and synergetic activities increasing connectivity within the city, thereby improving economic performance and labor market health of that particular city.

### TECHNICAL FIELD

The present disclosure generally relates to the technical field of online social networking services, and in an embodiment, but not by way of limitation, to a data mining functionality of online social networking services, and more particularly, to an analysis of an aggregated user profile and connectivity data in an online professional networking service for building a recommendation system suggesting specific actions and economic development interventions for a city such as promoting particular occupations or industrial areas within a city, and such as networking users for finding more optimal occupational opportunities, in order to improve economic performance and labor market health of the city.

### BACKGROUND

An online social networking service, such as LinkedIn®, allows members to declare information about themselves, such as their professional qualifications or skills. In addition to information the members declare about themselves, an online social networking service may gather and track information pertaining to behaviors of members with respect to the online social networking service and social networks of members of the online social networking service. Analyzing a vast array of such information may help to come up with solutions to various problems that may not otherwise have clear solutions, and/or may not even be soluble without the benefit of the social networking service.

### DESCRIPTION OF THE DRAWINGS

Some embodiments are illustrated by way of example and not limitation in the accompanying drawings, in which:

FIG. 1 is a block diagram of the functional modules or components that comprise a computer network-based online social networking service, including application server modules consistent with some embodiments of the invention;

FIG. 2 is a block diagram depicting some example application server modules of FIG. 1;

FIGS. 3A-3F are a flow diagram illustrating an example method of analyzing connections in an online social networking service to identify a particular occupation in a particular city and recommending actions to be taken based on the identified occupation;

FIG. 4 is a flow diagram illustrating an example method of examining the correlation between data from an online social networking system relating to persons and data relating to a city;

FIG. 5 illustrates an exemplary member profile page, according to various embodiments; and

FIG. 6 is a block diagram of a machine in the form of a computing device within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of the various aspects of different embodiments of the present invention. It will be evident, however, to one skilled in the art that the present invention may be practiced without all of the specific details and/or with variations, permutations, and combinations of the various features and elements described herein.

The present disclosure describes methods, systems, and computer program products for analyzing online professional network connectivity data within a particular city, and for creating a recommendation system for actions that the city can take to in order to increase its economic performance and labor market health. More specifically, the methods, systems, and computer program products analyze connections among persons in a city in an online social networking system, and identify occupations and industrial/business areas of the persons across the city from profiles of those persons in the online social networking system. This relationship of persons, occupation, and connectivity can be referred to as the urban genome of a city. This analysis is used to build a predictive model for the average expected connectivity of a person within a given city and industry having a certain occupation type. Thereafter, for each identified occupation and industrial area, the system first calculates a degree of connectivity as well as its more advanced parameters, such as spatial and categorical diversity of the connections of persons having the identified occupation and/or industrial area in their profiles. Secondly, for each identified occupation and industry within a city of interest, the system compares its connectivity parameters to the level predicted by the model identifying over-performing and underperforming spots. The system then selects one or more occupations and industries that demonstrate the highest level of anomaly in their performance. The city can then analyze the reasons and take actions to promote such occupations or lines of business in order to improve labor market conditions, thereby creating a basis for improving economic performance of a city. The concept of online social networks is intimately tied to computers and computer networks, and the concept of connectivity, degree of connectivity, and connectivity graphs is intimately tied to the online social network.

By way of background, a member of an online social networking service may declare one or more educational, professional, and/or personal interest qualifications or attributes. As a result, an online social networking service may have a vast array of information pertaining to other members, including data items pertaining to education, work experience, skills, interests, or other qualifications of each other member. A search of this information may discover common attributes between a user-searcher and the entities located in the search. The presentation of these common attributes in the search result makes the search results more valuable to the user.

In various embodiments, a back-end algorithm may be configured to identify the attributes of a member based on information that the member specifies about herself or himself and that is stored in the member's profile, information that the system collects pertaining to the member (e.g., behavior data, such as articles read, pages browsed, messages posted, connections made, or other actions), information about declared or acknowledged connections of a member (e.g., social graph data), and so on. The occupational attribute of members and connectivity of members are of particular import to the embodiments of this disclosure.

Other advantages and aspects of the present inventive subject matter will be readily apparent from the description of the figures that follows.

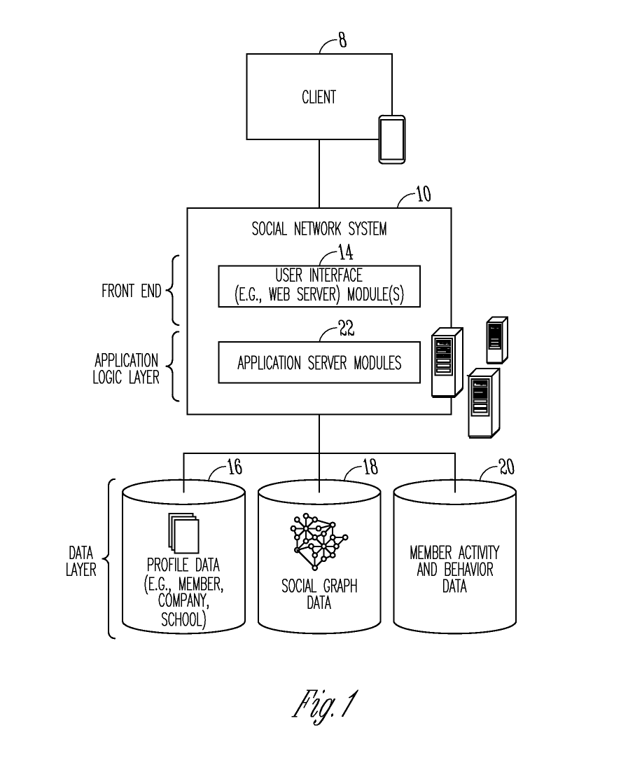

FIG. 1 is a block diagram of the functional modules or components that comprise a computer-based or network-based online social networking service 10 consistent with some embodiments of the invention. As shown in FIG. 1, the online social networking service 10 is generally based on a three-tiered architecture, comprising a front-end layer, application logic layer, and data layer, and can communicate with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary details, various functional modules and engines that are not germane to conveying an understanding of the inventive subject matter have been omitted from FIG. 1. However, a skilled artisan will readily recognize that various additional functional modules and engines may be used with an online social networking service, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the online social networking service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the online social networking service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the online social networking service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generate various user interfaces (e.g., web pages) with data retrieved from various data sources in the data layer. With some embodiments, individual application server modules 22 are used to implement the functionality associated with various applications, services and features of the online social networking service. For instance, a messaging application, such as an email application, an instant messaging application, or some hybrid or variation of the two, may be implemented with one or more application server modules 22. Of course, other applications or services may be separately embodied in their own application server modules 22.

The online social networking service may provide a broad range of applications and services that allow members the opportunity to share and receive information, often customized to the interests of the member. For example, with some embodiments, the online social networking service may include a photo sharing application that allows members to upload and share photos with other members. As such, at least with some embodiments, a photograph may be a property or entity included within a social graph. With some embodiments, members of an online social networking service may be able to self-organize into groups, or interest groups, organized around a subject matter or topic of interest. Accordingly, the data for a group may be stored in a database. When a member joins a group, his or her membership in the group will be reflected in the social graph data stored in the database with reference number 18. With some embodiments, members may subscribe to or join groups affiliated with one or more companies. For instance, with some embodiments, members of the online social networking service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modeled with the social graph data of the database with reference number 18.

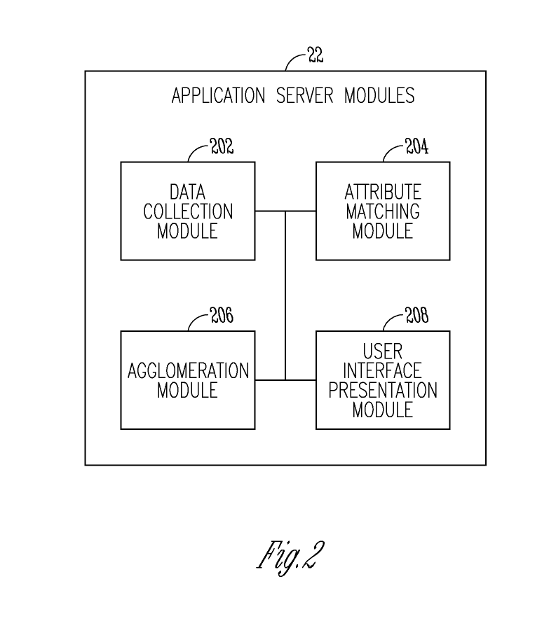

FIG. 2 is a block diagram depicting some example application server modules 22 of FIG. 1. A data collection module 202 may be configured to collect, for example, attributes corresponding to members and other entities such as groups, employers, and job postings of an online social networking service. Such data may include profile data, behavior data, endorsement data, online social networking service data, occupation data, and connectivity data. An attribute matching module 204 may be configured to match up common attributes between a plurality of persons on the online social networking service, and agglomeration module 206 may be configured to cluster persons who have the same or similar occupation indicated in their profiles. Besides exact matching, inferences can be made relating to the members on the online social networking system, and the inferences may be based on an application of a Hidden Markov Model (HMM) or various other algorithms. A user interface presentation module 208 may be configured to generate a user interface for presentation to the user. The user interface may include information pertaining to the cluster of members who share the same or similar occupation and/or the members who are connected.

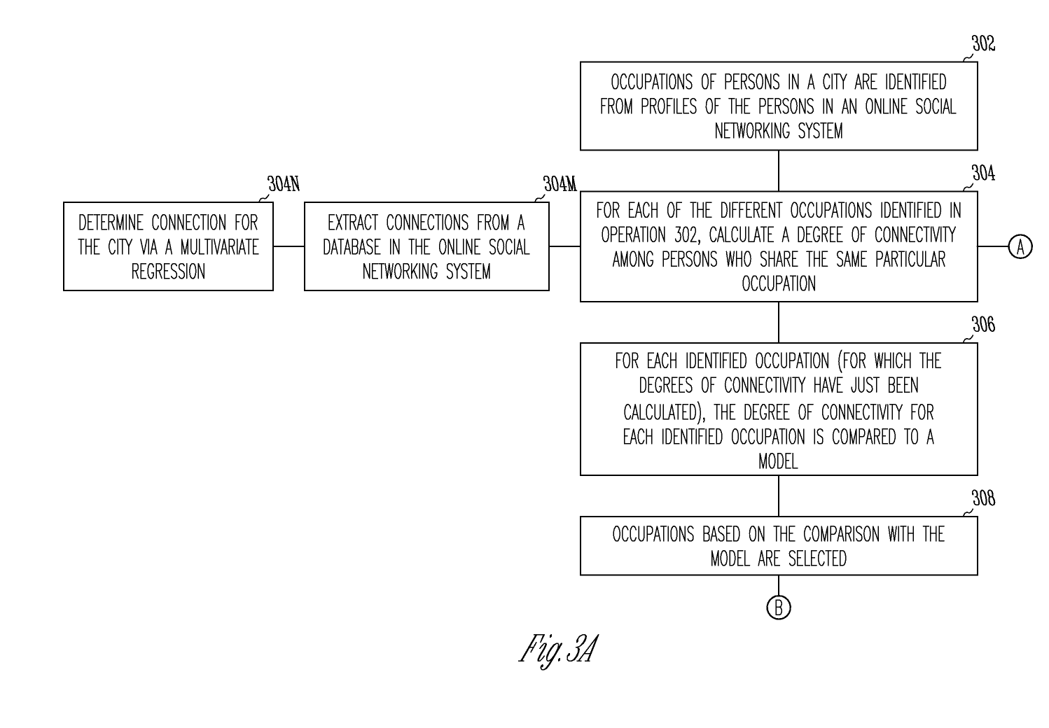

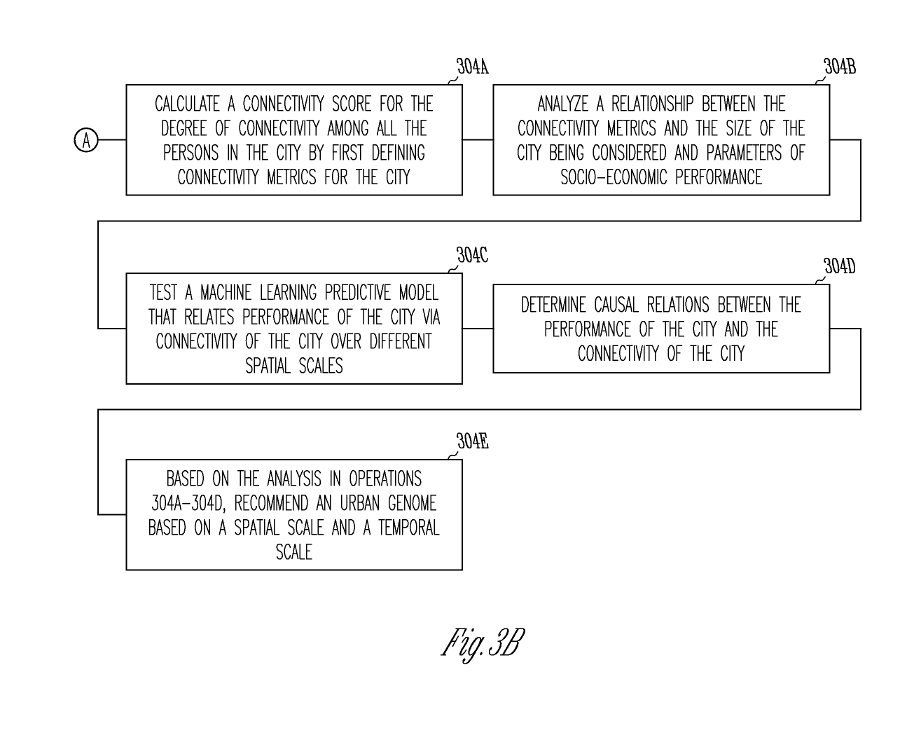

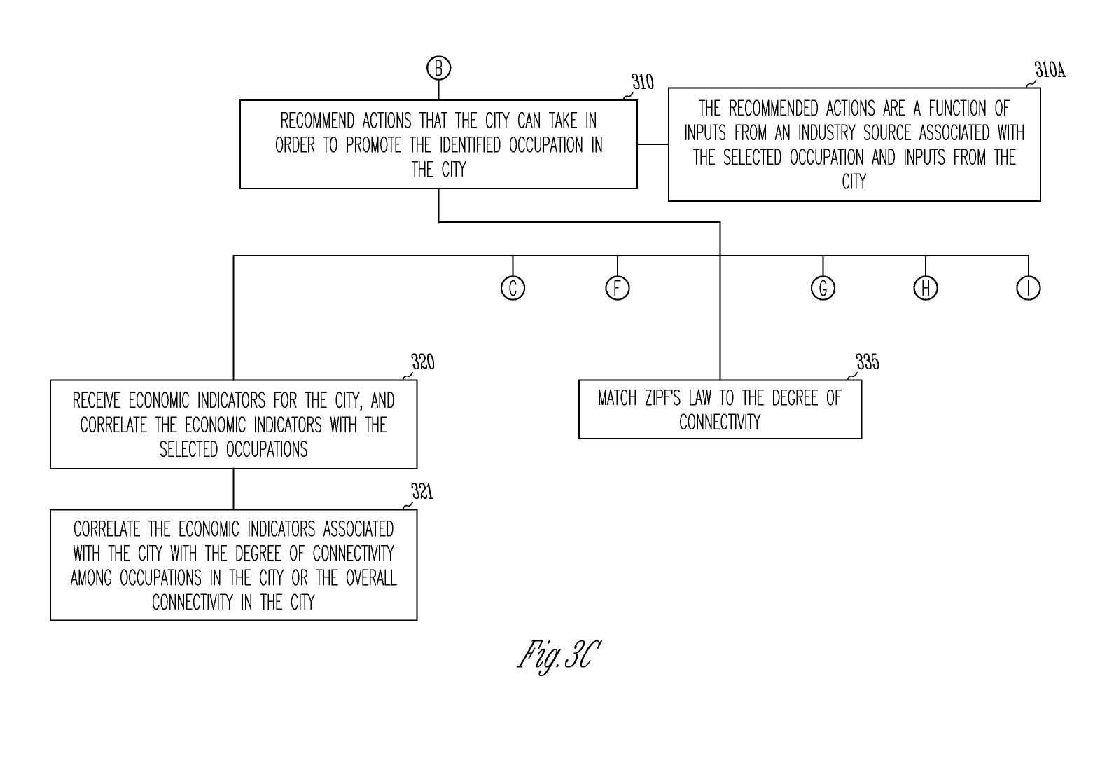

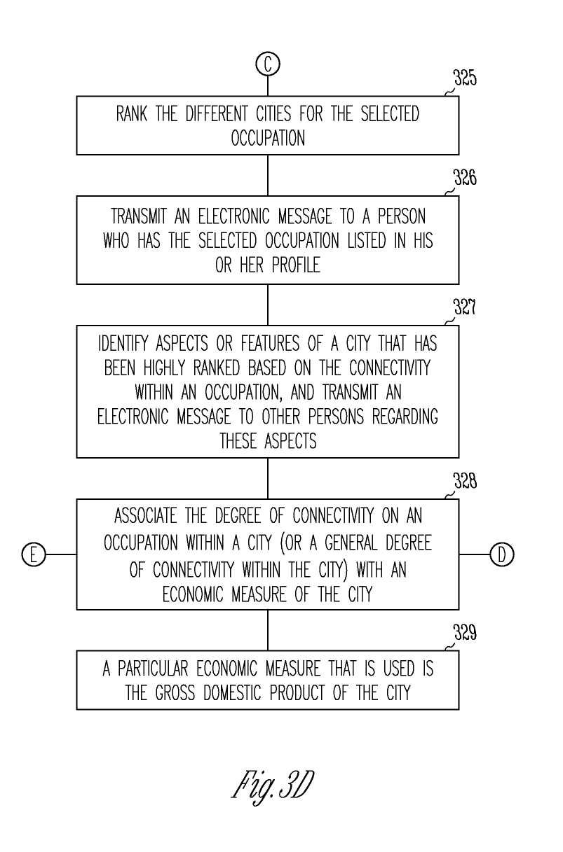

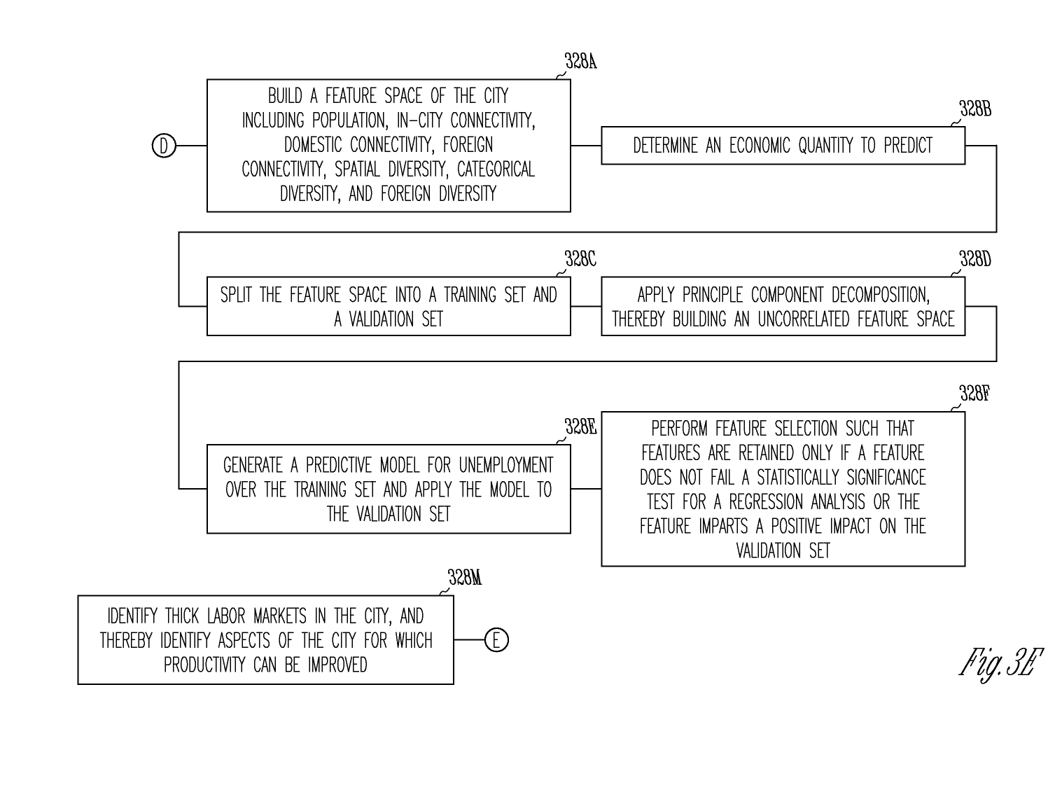

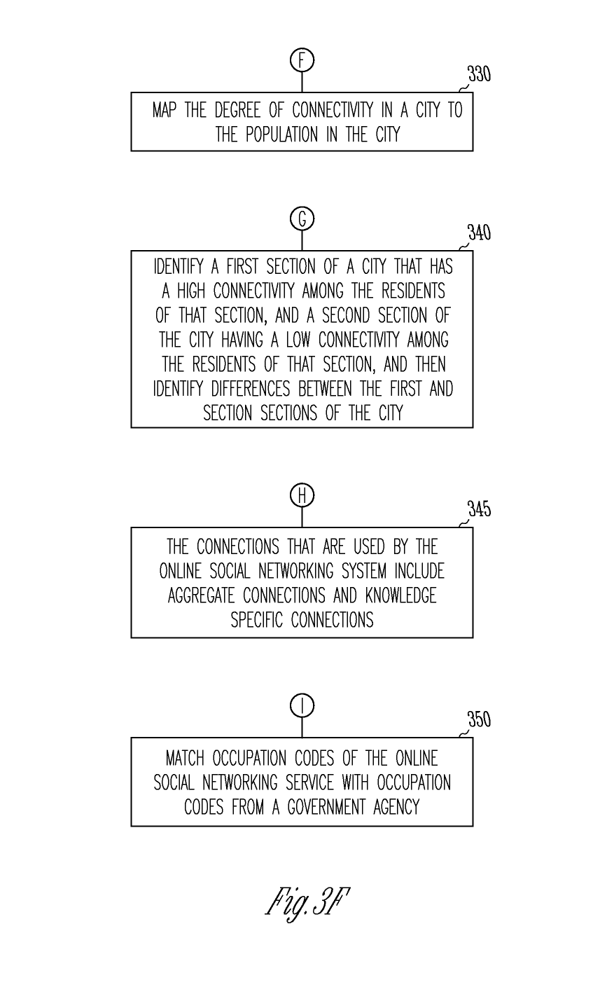

FIGS. 3A-3F are a flow diagram illustrating an example method of identifying occupations of persons in a city as stored in on online social networking service's profile database, determining the connectivity of persons within a particular occupation in a particular city using the profile database, and making recommendations to promote occupations with a high level of connectivity in the particular city. In various embodiments, the method 300 may be implemented by one or more of the modules of FIG. 2. FIGS. 3A-3F include a number of process blocks 305-350. Though arranged somewhat serially in the example of FIGS. 3A-3F, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 3A-3F, at 302, occupations of persons in a city are identified from profiles of the persons in an online social networking system. As noted above, members of an online social networking system provide information about their personal, education, and employment histories. It is primarily from a person's employment history that the system identifies all the occupations of all the persons in the particular city. The term occupations includes the concept of the type of job or job title as well as the industry with which the job is associated.

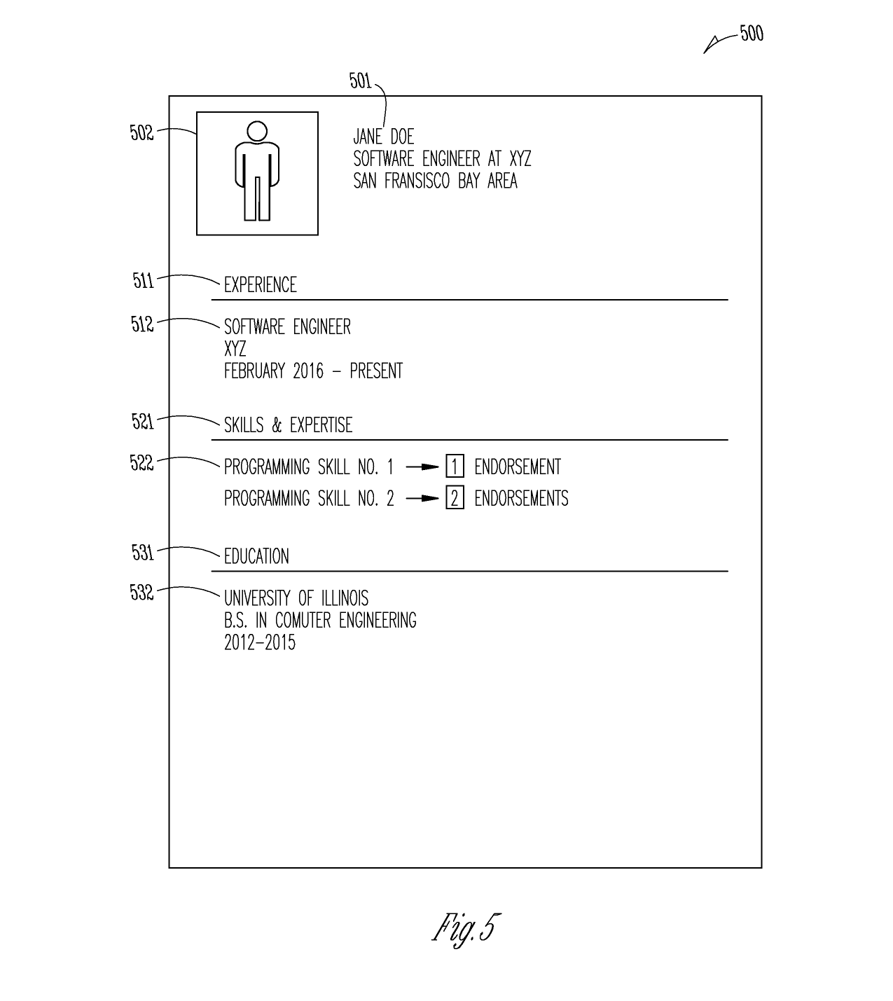

More specifically, each member of an online social network service (e.g., LinkedIn®) may be associated with a member profile page that includes various information about that member. An example of a member profile page 500 of a member (e.g., a LinkedIn® page of a member “Jane Doe”) is illustrated in FIG. 5. As seen in FIG. 5, the member profile page 500 includes identification information 501, such as the member's name (“Jane Doe”), the member's current employment position (“Software Engineer at XYZ”), and geographic address/location information (“San Francisco Bay Area”). The member's profile page 500 also includes a photo area 502 for displaying a photograph of the member. Further, the member profile page 500 includes various sections (also known as fields). For example, member profile page 500 includes an experience section 511 including listings of experience positions (e.g., employment experience position 512), a skills and expertise section 521 including listings of various skills 522 of the member and endorsements of each of these skills received by other members, and an education section 531 including listings of educational credentials of the member (e.g., university degree or diploma 532 earned or currently being earned by the member). Note that the member profile page 500 is merely exemplary, and while the member profile page 500 includes certain sections or fields (e.g., experience sections and educations sections), it is apparent that these sections or fields may be supplemented or replaced by other sections or fields (e.g., a general portfolio section/field, a multimedia section/field, an art portfolio section/field, a music portfolio section/field, a photography portfolio section/field, and so forth). Those skilled in the art will understand that a member profile page may include other information, such as various identification information (name, username, email address, geographic address, networks, location, phone number, etc.), education information, employment information, resume information, activities, group membership, images, photos, preferences, news, status, links or URLs on the profile page, and so forth.

At 304, for each of the different occupations identified in operation 302, the system calculates a degree of connectivity among persons who share the same particular occupation. For example, the system calculates the degree of connectivity among all the persons in the city who are in the field of accounting, the degree of connectivity among all the persons in the city who are in the field of software engineering, and the degree of connectivity among all the persons in the city who are in the field of health care. In an embodiment, the degree of connectivity is a simple summation of the number of connections of all the persons who are in a particular field. In another embodiment, a connectivity score is calculated, which is discussed in more detail below. At 306, for each identified occupation (for which the degrees of connectivity have just be calculated), the degree and parameters of connectivity for each identified occupation are compared to a model's estimate, which is computed as the average expected connectivity predicted by the model taking into account all the relevant trends. For example, if the degree of connectivity is a simple summation of the number of connections for all of the persons in a particular field in the city, then this aggregate number of connections (degree of connectivity) is compared to a model's estimate. At 308, one or more occupations are selected based on the comparison to the model. In most instances an occupation is selected because it exceeds a model estimate, thereby indicating a high degree of connectivity among the persons in that city who share that occupation. As discussed in more detail below, such high degrees of connectivity can be correlated with economic indicators or measurements associated with the city, or can be used to predict an economic indicator or the general economic health of the city. In other instances, it may be desirable to select occupations that fall below a model estimate. For example, one could consider occupations with connectivity falling below a specified model estimate as indicating that additional attention needs to be promoted within a given city in order to better balance the profile of its labor market or may be strategically advantageous to develop, while the others may be positively identified and considered already well developed within a given city, not requiring additional aid.

At 310, the system recommends actions that the city can take in order to promote the identified occupation in the city. Such actions can be retrieved from a database that maps such actions to particular occupations. When the connectivity for a certain industry drops considerably below the model expectation, and is of strategic importance for a community, the database may recommend certain actions to support the increase of those connections. For example, professionals in a city's growing medical or health care field may be notified to attend medical conferences at convention centers, or to regularly attend seminars at universities, to facilitate connections between others within the industry and aid indirectly in the growth of that industry through knowledge transfers. Such recommendations can, in aggregate, be made to the city to expand its conference center facilities and/or seek funding from the state government to expand the medical programs or career development and vocational training opportunities at the university in the city.

At 320, the system receives one or more economic indicators for the city, and the system correlates the one or more economic indicators with the occupations that were selected based on the comparison to the model. For example, the system can calculate the labor market thickness for a particular occupation within multiple cities. The system can then suggest cities with high labor market thickness for a person with the skills associated with that occupation. Such information can be used by the city to take steps to see where they have deficiencies in particular labor markets, or may be more easily and competitively developed relative to other industries.

Similarly, at 321, the system can model the one or more economic indicators associated with the city with the characteristics of connectivity among occupations in the city or simply the overall connectivity in the city. For example, the system can use the connectivity characteristics for the certain industries and occupations as a feature space for learning a regression model predicting the percentage of home ownership within that occupation in the city. By comparing the connectivity characteristics and the degree of home ownership for several cities, the system can determine if a correlation exists. Then, by further training the model on a certain subsample of cities and evaluating it on the different subsample, one can validate if the learned dependence is indeed generalizable. The home ownership status of a member can be determined from the property records of the county in which the city is located. If the above model appears to be efficient and generalizable, then by simply tracking the variation of the connectivity parameters of any city in the future, an inference could be made regarding the expected percentage of home ownership in that city, even before it can be obtained from actual surveys, enabling an early policy intervention or stimulus if needed.

As noted above, at operation 306, the degree of connectivity of an occupation in a particular city is compared to a model estimate. At 325, the online social networking service identifies cities that transgress the model estimate, and the online social networking service ranks the different cities in which the occupation transgresses the model estimate. Operation 325 could be helpful in identifying cities in which a particular occupation is thriving, and/or identifying what occupations are best suited for a particular city. At 326, the online social networking service transmits an electronic message to a person who has the identified occupation listed in his or her profile. Such a feature can be used by a city to connect with people who are involved in the occupation in which the city thrives, and attract even more people to the city within that occupation, thereby increasing activities and knowledge transfer that may assist in the improvement of the economic well-being of the city. Such a feature can also be used to recommend or auto-recommend jobs to the users of the online social networking system.

At 327, the online social networking system identifies aspects or features of a city that have been highly ranked based on the connectivity within an occupation, and transmits an electronic message to other persons regarding these aspects. The persons to which the electronic message is transmitted could be an official of another city. These aspects can be related to things for which the city has no or little control over, such as weather and proximity to natural bodies of water, or the aspects can be related to things for which the city has control over and for which the city has expended resources to develop. For example, the city may have invested in a new or refurbished concert hall, a city orchestra, and also youth music programs. Such investment, along with the attraction of its high ranking for a particular occupation, can increase the desirability and attractiveness for the city for other persons within that occupation.

At 328, the online social networking system associates the degree of connectivity of an occupation within a city (or a general degree of connectivity within the city) with an economic measure of the city. The city can then be ranked based on the economic measure or the association of the connectivity with the economic measure. For example, the online social networking system may determine for several cities that whenever there is a high connectivity among software engineers in a city, there is a both a high occupancy rate in apartments and also a high level of new construction of apartments, with all other factors being equal. Then, in the future, whenever the connectivity of software engineers in a city is analyzed and determined to be on the high side, and accounting for other economic conditions, an inference can be made that the apartment housing market is healthy in that city, which may point to a need for a change in construction policy to support the development of new housing. As indicated at 329, a particular economic measure to consider is the gross domestic product of the city. That is, determining and using the relationship between the connectivity of an occupation in a city and the gross domestic product of that city, among other relationships in the urban genome.

At 330, the online social networking system maps the degree of connectivity in a city to the population in the city. As with other embodiments, the connectivity could be a general connectivity over all occupations in the city, the connectivity for a particular occupation in the city, or characteristics of said connections such as those within or outside of that unit of analysis. In general, the online social networking system could possibly determine that there is a direct correlation between the degree of connectivity in a city and the population in a city. With such a direct correlation, the population of a city could be more easily determined, or at least estimated, by simply looking at the connectivity of the members of the social networking service.

At 335, the online social networking service matches Zipf's Law to the degree of connectivity. As known to those of skill in the art, Zipf's Law relates to the frequency of any word and how it is inversely proportional to its rank in the frequency. Similarly, it has been found that the population of a city generally scales with the economic rank (R) of a city, that is, 1/R. Also, it has been found that connectivity scales in a similar manner, that is approximately 1/R̂q, wherein q is greater than 1, and that the size distribution of a city scales with a population greater than S, that is, 1/S.

At 340, the online social networking system identifies a first section of a city that has a high connectivity among the residents of that section, and a second section of the city having a low connectivity among the residents of that section, and then identifies differences between the first and second sections of the city. For example, after analyzing several different cities, it may be determined that there is a correlation between a high degree of connectivity in a certain section of the city with a conglomeration of cafes or restaurants. Thereafter, a city could perhaps determine the areas of a city wherein there is a high connectivity, and use this to encourage restaurant entrepreneurs to start new restaurants in that particular section of the city.

As noted at operation 310, the online social networking system recommends actions that the city can take in order to promote the identified occupation in the city. At 310A, the recommended actions are a function of inputs from an industry source associated with the occupation and inputs from the city. In this manner, industry sources, city officials, and the online social networking system can work hand in hand at promoting different aspects of the city. For example, the online social networking system may determine that there is a high connectivity among medical professionals in a city. Industry sources may then chime in that the city would benefit from a new research hospital in the city, and city officials may be aware of a particular piece of real estate or section of the city that would benefit from a new real estate development project.

As indicated at 345, the connections that are used by the embodiments of the online social networking system include aggregate connections and knowledge specific connections. Aggregate connections simply refer to the general connectivity of all the members of an online social networking system in a particular city. Knowledge specific connections relate to the connections among persons who share the same or similar occupations. As noted, either aggregate connections or knowledge specific connections can be used in the different embodiments disclosed herein.

As noted above, at operation 304, for each of the different occupations identified in operation 302, the system calculates a degree of connectivity among persons who share the same particular occupation. As further noted above, this can involve a calculation of a connectivity score. The calculation of a connectivity score can involve several steps. For example, the online social networking system can calculate a connectivity score for the degree of connectivity among all the persons in the city by first defining connectivity metrics for the city (304A). In an embodiment, as previously noted, these connectivity measures can refer to whether the connectivity is an aggregate connectivity or a knowledge-specific or occupation-based connectivity. At 304B, the online social networking system analyzes a relationship between the connectivity metrics and the size of the city being considered and parameters of socio-economic performance. Such an analysis can include determining that larger cities have greater degrees of aggregate and knowledge-based connectivity, and that greater degrees of connectivity in a city indicate that there should be lower unemployment in the city, especially for the relevant occupation when considering knowledge-based connectivity. At 304C, the online social networking system tests a machine learning predictive model that relates performance of the city via connectivity of the city over different spatial scales. For example, the online social networking system can analyze and machine-learn the relationship between connectivity and employment rate for different sections of a city. This machine-learned knowledge can then be used to either infer employment rate of other sections of the city based on connectivity, infer employment rate in combinations of city sections based on connectivity, and/or to identify sections of a city that are experiencing employment issues so that actions can be taken to stimulate the micro-economy in those sections. At 304D, these actions can be taken a step further, and the online social networking system can determine causal relations between the performance of the city and the connectivity of the city. For example, through analysis such as machine-learning, the online social networking system could determine that a higher degree of connectivity correlates with and indeed results in both a lower unemployment rate among persons in a particular occupation, correlates with and indeed results in more people in that occupation relocating to the city, and correlates with and indeed causes a robust real estate market in the city. Then, at 304E, based on the analysis in operations 304A-304D, the online social networking system can recommend an urban genome based on a spatial scale and a temporal scale. For example, the online social networking system could determine that the genomic makeup of a city consists of about 20% of the population involved in information technology, about 15% of the population involved in healthcare, about 20% of the population involved in finance and accounting, about 10% of the population involved in legal services, about 10% of the population involved in education, about 5% of the population involved in food services, about 5% of the population involved in construction, and the remaining 15% involved in other occupations and industries. Additionally, the online social networking system could determine what sectors of the city these different occupations are located (spatial), and any trend in growth or contraction in these different occupations (time).

As discussed above, at operation 328, the online social networking system associates the degree of connectivity of an occupation within a city (or a general degree of connectivity within the city) with an economic measure of the city. Operations 328A-328F disclose an example of operations in such an analysis of the degree of connectivity in determining for example the gross domestic product of the city. At 328A, the online social networking system builds a feature space of the city including population, in-city connectivity, domestic connectivity, foreign connectivity, spatial diversity, categorical diversity, and foreign diversity. The population can relate to the entire population of the city or certain sections of the city. The in-city connectivity relates to the degree of connectivity in the city, the domestic connectivity relates to the degree of connectivity within the pertinent country, and the foreign connectivity relates to connectivity in countries other than the pertinent country. The spatial diversity relates to the amount of different sections of a city, the categorical diversity relates to the different types of occupations found within a city, and the foreign diversity relates to the number or percentage of foreign persons living in the city. The feature space then includes data relating to all of these measures.

At 328B, the online social networking system determines an economic quantity to predict. Examples of such economic quantities include an unemployment rate and real personal income. At 328C, the online social networking system splits the data sample into training, validation, and test sets. This could be done randomly and iterated up to ten times in order to insure independence of the conclusions on the specific split (this technique is commonly referred to as cross-validation) At 328D, the online social networking system applies principle component decomposition to the original space of multiple connectivity characteristics, thereby building an uncorrelated feature space, so that impact of each feature on predicting the output variable can be evaluated separately from the impact of all other features, enabling efficient feature selection and interpretation. At 328E, the online social networking system generates a predictive model for the key characteristics of the city economic performance, such as average real personal income, unemployment, etc., to be trained over the training set and after appropriate feature and model selection over the validation set, evaluates the model over the test set. The predictive model itself is selected among different generalized linear regression models with the coefficients fit over the training set and the functional shape selected to work the best over the validation set. At 328F, the online social networking system performs feature selection such that features are retained only if a feature does not fail a statistically significance test for a regression analysis and if the feature imparts a positive impact on the model performance over the validation set. The generated model could be applied to the early prediction of the emerging socio-economic trends through the temporal variations in the feature space as well as for estimating socio-economic quantities at the spatial scales for where their official measurements are non-existent or inconsistent.

Somewhat related to the determination and use of economic measures of the operations of 328-328F, the online social networking system can specifically identify thick labor markets in the city, and thereby identify aspects of the city for which productivity can be improved (328M). A thick labor market refers to a labor market wherein there is both an increased number of employers and an increased number of workers. One way labor markets are made thick is via globalization and the ability to work online and remotely via the Internet. Therefore, the online social networking system can identify labor market thickness by examining the degree of connectivity, especially the degree of domestic connectivity (as compared to in-city connectivity), and most especially the degree of foreign connectivity. A higher degree of domestic and foreign connectivity logically leads to more employers and more workers being available to any particular city. This information and data can be used by the city to improve many aspects of the city, such as identifying aspects of the city for which productivity can be improved. For example, if the domestic and foreign degrees of connectivity are high for a particular occupation in the city, then such pool of employers and laborers could be encouraged by the city to relocate to or at least get involved with the economic aspects of the city relating to that occupation, and thereby increase the overall productivity of that occupation in the city.

At 350, the online social networking system matches its own occupation codes with occupation codes from a government agency. For example, the online social networking system can match its occupation codes to similar codes from the Bureau of Labor Statistics (BLS). The online social networking system can then use this mapping to retrieve data from the BLS relating to any particular occupation, compare and analyze the BLS data with the connectivity data for the occupation, and then generate inferences based on this analysis. For example, the online social networking system may indicate a high degree of connectivity among software engineers on the west coast of the U.S., and the BLS data may indicate a high degree of job mobility among software engineers on the west coast. The relationship then between connectivity and job mobility can be used in connection with the connectivity data of other geographical areas to infer the job mobility of those other areas.

At 304M, the online social networking system extracts the connections from a database in the online social networking system. At 304N, the online social networking system determines connections for the city via a multivariate regression. Such a multivariate regression can take the following form:

log(connections)=β₀+β₁ log(population)+β₂ log(gross domestic product)+β₃ log(income)+β₄ log(unemployment).

The connections, population, gross domestic product, income, and unemployment are all for a particular city. The β coefficients are all determined by the multivariate regression.

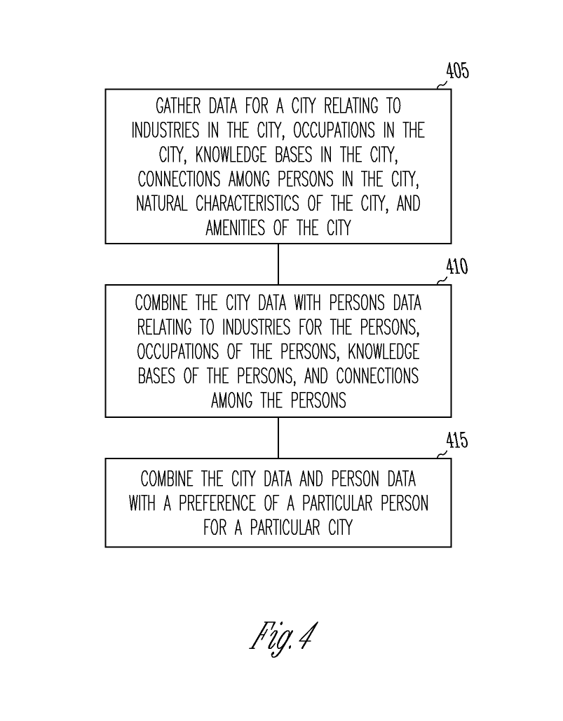

FIG. 4 relates to an embodiment of an online social networking system that examines the correlation between data from an online social networking system relating to persons, and data relating to a city. Specifically, at 405, the online social networking system gathers data for a city. This city data can relate to industries in the city, occupations in the city, knowledge bases in the city, connections among persons in the city, natural characteristics of the city, and amenities of the city. At 410, the online social networking system combines the city data with data relating to persons. The data relating to persons can further relate to industries for the persons, occupations of the persons, knowledge bases of the persons, and connections among the persons. At 415, the online social networking system combines the city data and the data relating to the persons with a preference of a particular person for a particular city. That is, in an embodiment, the online social networking system can recommend to a particular person a particular city that may be a good fit for that person based on the foregoing data analysis.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

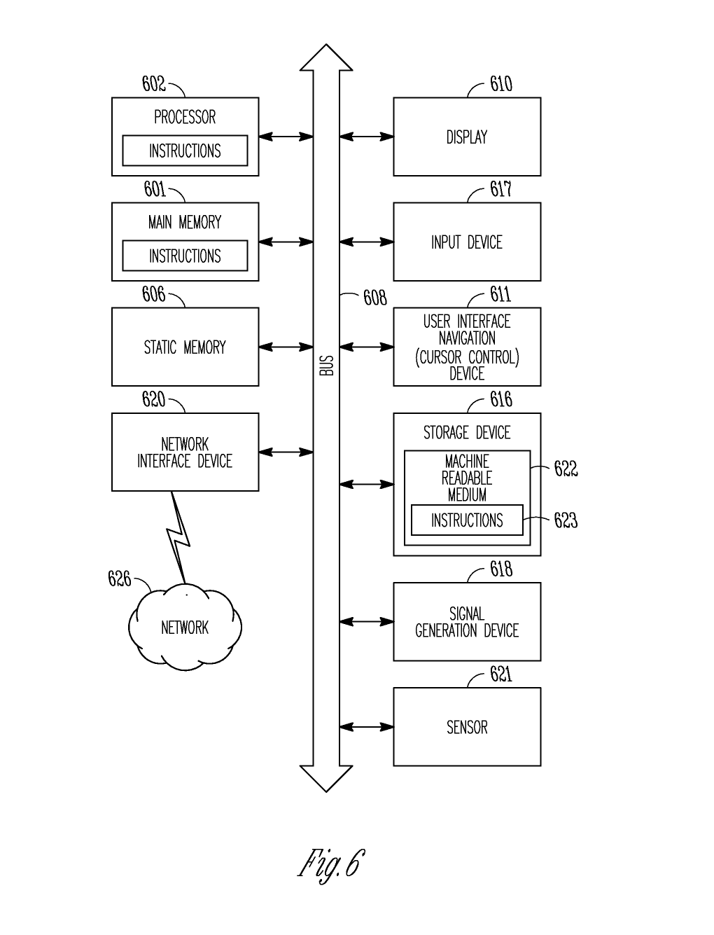

FIG. 6 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 601 and a static memory 606, which communicate with each other via a bus 608. The computer system 600 may further include a display unit 610, an alphanumeric input device 617 (e.g., a keyboard), and a user interface (UI) navigation device 611 (e.g., a mouse). In one embodiment, the display, input device and cursor control device are a touch screen display. The computer system 600 may additionally include a storage device 616 (e.g., drive unit), a signal generation device 618 (e.g., a speaker), a network interface device 620, and one or more sensors 621, such as a global positioning system sensor, compass, accelerometer, or other sensor.

The drive unit 616 includes a machine-readable medium 622 on which is stored one or more sets of instructions and data structures (e.g., software 623) embodying or utilized by any one or more of the methodologies or functions described herein. The software 623 may also reside, completely or at least partially, within the main memory 601 and/or within the processor 602 during execution thereof by the computer system 600, the main memory 601 and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 623 may further be transmitted or received over a communications network 626 using a transmission medium via the network interface device 620 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
one or more processors; and
a computer readable medium storing instructions that, when executed by the one or more processors, cause the system to perform operations comprising:
identifying occupations and industrial areas of persons in a city from profiles of the persons in an online social networking system;
for each identified occupation and industrial areas, calculating a degree and a structure of connectivity among persons having the identified occupation in the profiles;
for each identified occupation and industrial area, comparing the degree and the structure of connectivity to a model;
selecting an occupation based on the comparison with the model; and
recommending actions for promoting the occupation in the city, thereby increasing socio-economic performance of the city.

2. The system of claim 1, wherein the operations comprise receiving one or more economic indicators for the city, and correlating the one or more economic indicators with the selected occupation and industrial area.

3. The system of claim 2, wherein the operations comprise correlating the one or more economic indicators with the degree and the structure of connectivity.

4. The system of claim 1, wherein the operations comprise ranking cities relating to the selected occupation or industrial area based on connectivity among persons in the city who have the occupation and industry in their profile.

5. The system of claim 4, wherein the operations comprise transmitting an electronic message to a person having an indication of the selected occupation or industry in a profile of the person.

6. The system of claim 4, wherein the operations comprise identifying aspects of a city with a high ranking, and transmitting an electronic message including the identified aspects to another city.

7. The system of claim 4, wherein the operations comprise associating the degree and the structure of connectivity with an economic measure of the city and ranking the city based on the economic measure.

8. The system of claim 7, wherein the economic measure of the city comprises parameters of socio-economic performance of the city such as a gross domestic product of the city, average income, and unemployment rate.

9. The system of claim 1, wherein the operations comprise mapping the degree and the structure of connectivity of the selected occupation and industrial area to a population of the city.

10. The system of claim 1, wherein the operations comprise matching Zipf's law to the degree of connectivity.

11. The system of claim 1, wherein the operations comprise identifying a first section of the city having residents with a high connectivity and a second section of the city having residents with a low connectivity, and identifying differences between the first section and the second section.

12. The system of claim 1, wherein the recommended actions are a function of inputs from an industry source associated with the selected occupation and inputs from the city.

13. The system of claim 1, wherein the connections comprise aggregate connections and knowledge specific connections.

14. The system of claim 1, wherein the operations comprise a connectivity scoring by:
defining connectivity metrics for the city;
analyzing a relationship between the connectivity metrics and a size of the city and parameters of socio-economic performance;
testing a machine learning predictive model that relates performance of the city via connectivity of the city over different spatial scales;
determining causal relations between the performance of the city and the connectivity of the city; and
recommending an urban genome based on a spatial scale and a temporal scale.

15. The system of claim 1, wherein the operations comprise determining the socio-economic performance of the city, such as gross domestic product, real personal income and its segregation, unemployment rate, or other parameters by:
building a feature space of the city comprising population and its structure, in-city connectivity, domestic connectivity, foreign connectivity, internal and cross-industry connectivity, spatial and categorical diversity of domestic and foreign connections;
determining an economic quantity to predict using the feature space;
applying principle component decomposition, thereby building an uncorrelated feature space;
generating a predictive model for the selected economic quantity based on the available feature space;
cross-validating the model by spatially or temporally splitting the available data sample into a training set and a validation set; and
performing feature selection such that features are retained only if a feature does not fail a statistically significance test for a regression analysis or the feature imparts a positive impact on the model performance over the validation set.

16. The system of claim 1, wherein the operations comprise identifying thick labor markets in the city, thereby identifying aspects of the city for which productivity can be improved.

17. The system of claim 1, wherein the operations comprise matching occupation codes from the online social networking system with occupation codes from a government agency including the United States Bureau of Labor Statistics.

18. The system of claim 1, wherein the connections are extracted from a database in the online social networking system.

19. The system of claim 18, wherein the connections for the city are further determined via a multivariate regression as follows:
log(connections)=β₀+β₁ log(population)+β₂ log(gross domestic product)+β₃ log(income)+β₄ log(unemployment).

20. The system of claim 1, wherein the degree of connectivity comprises a degree and structure of connectivity within the city, a degree and structure of connectivity within a country, and a degree and structure of connectivity among two or more countries.

21. A system comprising:
one or more processors; and
a computer readable medium storing instructions that, when executed by the one or more processors, cause the system to perform operations comprising:
gathering data for a city relating to industries in the city, occupations in the city, knowledge in the city, connectivity among persons in the city, natural characteristics of the city, and amenities of the city;
combining the city data with person data relating to an industry for the person, an occupation of the person, knowledge of the person, and connectivity of the person; and
combining the city data and person data with a preference of the person for a particular city.
